(19) United States
(12) Patent Application Publication
(10) Pub. No.: US 2016/0369419 A1
(43) Pub. Date: Dec. 22, 2016

(54) PLATING ADHESION PROMOTION

(71) Applicant: UNITED TECHNOLOGIES CORPORATION, Hartford, CT (US)

(72) Inventors: Michael S. Miarecki, Enfield, CT (US); Charles R. Watson, Windsor, CT (US); James T. Roach, Vernon, CT (US)

(21) Appl. No.: 14/903,866

(22) PCT Filed: Jul. 9, 2014
(86) PCT No.: PCT/US2014/045907

§ 371 Date: Jan. 8, 2016

Related U.S. Application Data
(60) Provisional application No. 61/844,108, filed on Jul. 9, 2013.

(51) Int. Cl. C25D 5/56; C25D 3/02; F01D 25/00; C23C 18/16

(52) U.S. Cl. CPC C25D 5/56; C23C 18/1633; C25D 3/02; F01D 25/005; F05D 2220/32; F05D 2300/11; F05D 2300/132; F05D 2300/1616; F05D 2300/177; F05D 2300/603; F05D 2300/614; F05D 2300/30; F05D 2230/30

(57) ABSTRACT

A plated polymer component is disclosed. The plated polymer component may comprise a polymer substrate having an outer surface, and a metal plating deposited on the outer surface of the polymer substrate. The plated polymer component may further comprise an adhesion promoter at an interface between the polymer substrate and the metal plating.

### CROSS-REFERENCE TO RELATED APPLICATIONS

This application claims priority under 35 U.S.C. §119(e) to U.S. Provisional Patent Application Ser. No. 61/844,108 filed on Jul. 9, 2013.

### FIELD OF THE DISCLOSURE

The present disclosure generally relates to metal-plated polymer components and other materials having improved mechanical properties. More specifically, this disclosure relates to metal-plated polymer components having improved interfacial bond strengths.

### BACKGROUND

Metal-plated polymer components consist of a polymer substrate coated with a metal plating. These components are lightweight and, by virtue of the metal plating, exhibit markedly enhanced structural strength and capability over the structural strength and capability of the polymer substrate alone. These properties have made them attractive for component fabrication in many industries such as aerospace, automotive, and military equipment industries, where high-strength and lightweight materials are desired. For example, metal-plated polymer components continue to be explored for use in gas turbine engine applications to reduce the overall weight of the engine and improve engine efficiency and provide fuel savings. However, the strength and performance characteristics of metal-plated polymer materials may be dependent upon the integrity of the interfacial bond between the metal plating and the underlying polymer substrate. Even though the surface of the polymer substrate may be etched or abraded to promote the adhesion of metals to the polymer surface and to increase the surface area of contact between the metal plating layer and the polymer substrate, the interfacial bond strength between the metal plating and the polymer substrate may be the structurally weak point of metal-plated polymer structures. As such, the metal plating layers may become disengaged from polymer substrate surfaces which could lead to part failure in some circumstances.

The interfacial bond strength between the metal plating and the underlying polymer substrate may be compromised upon exposure to high temperatures, such as those experienced during some high-temperature engine operations. If metal-plated polymers are exposed to temperatures over a critical temperature or a sufficient amount of thermal fatigue (thermal cycling or applied loads at elevated temperatures) during operation, the interfacial bond between the metal plating and the polymer substrate may be at least partially degraded, which may lead to structural break-down of the component and possible in-service failure. Unfortunately, brief or minor exposures of metal-plated polymer components to structurally-compromising temperatures may go largely undetected in many circumstances, as the weakening of the bond between the metal-plating and the underlying polymer substrate may be difficult to detect. To provide performance characteristics necessary for the safe use of metal-plated polymer components in gas turbine engines and other applications, enhancements are needed to improve the interfacial bond strengths of metal-plated polymer components.

Clearly, a system is needed to improve the mechanical strength of the interfacial bond between metal platings and polymer surfaces in plated polymer components.

### SUMMARY OF THE DISCLOSURE

In accordance with one aspect of the present disclosure, a plated polymer component is disclosed. The plated polymer component may comprise a polymer substrate having an outer surface and a metal plating deposited on the outer surface of the polymer substrate. The plated polymer component may further comprise an adhesion promoter at an interface between the polymer substrate and the metal plating.

In another refinement, the adhesion promoter may comprise an organofunctionalized silane.

In another refinement, the organofunctionalized silane may have a structure Y—Si(OR)ₙ, where R is an organic group, and where Y and R are different types of reactive groups.

In another refinement, the metal plating may consist of a metal or metal alloy selected from the group consisting of nickel, cobalt, a nickel-cobalt alloy, copper, iron, chromium, zinc, and combinations thereof.

In another refinement, the polymer substrate may be formed from a thermoplastic material or a thermoset material.

In another refinement, the polymer substrate may be reinforced with reinforcing fibers selected from the group consisting of carbon fibers, glass fibers, and metal fibers.

In another refinement, a coupling agent may be applied to the surfaces of the reinforcing fibers.

In another refinement, the coupling agent that is applied to the surfaces of the reinforcing fibers may be an organofunctionalized silane having at least one carbon-silicon bond and at least one hydrolyzable bond.

In another refinement, the organofunctionalized silane that is applied to the surfaces of the reinforcing fibers may have a structure Y—Si(OR)ₙ, where Y is an organic group, and where Y and R are different types of reactive groups.

In accordance with another aspect of the present disclosure, a method of fabricating a plated polymer component is disclosed. The method may comprise: 1) forming a polymer substrate in a desired shape, 2) applying an adhesion promoter to an exposed surface of the polymer substrate, and 3) depositing a metal plating on the exposed surface of the polymer substrate.

In another refinement, the adhesion promoter may comprise an organofunctionalized silane.

In another refinement, the organofunctionalized silane may have the formula Y—Si(OR)ₙ, where Y is an organic group, and where Y and R are different types of reactive groups.

In another refinement, the polymer substrate may be formed with reinforcing fibers and a coupling agent may be applied to the surfaces of the reinforcing fibers, and the coupling agent may comprise an organofunctionalized silane having at least one carbon-silicon bond and at least one hydrolyzable bond.

In another refinement, the depositing the metal plating on the exposed surface of the polymer substrate may comprise: 1) activating the exposed surface with a catalyst layer, 2) depositing a first layer on the catalyst layer by electroless deposition, 3) depositing a second conductive layer on the first layer by electrolytic deposition, and 4) depositing the metal plating on the second layer.

In accordance with another aspect of the present disclosure, a plated polymer component is disclosed. The plated polymer component may comprise a polymer substrate and a metal plating deposited on an outer surface of the polymer substrate. The plated polymer component may be fabricated by a method comprising: 1) forming the polymer substrate in a desired shape, 2) applying an adhesion promoter to the exposed surface of the polymer substrate, and 3) depositing the metal plating on the exposed surface of the polymer substrate.

In another refinement, the adhesion promoter may comprise an organofunctionalized silane.

In another refinement, the organofunctionalized silane may have the formula Y—Si(OR)ₙ, where Y is an organic group, and where Y and R are different types of reactive groups.

In another refinement, the polymer substrate may be formed with reinforcing fibers and a coupling agent may be applied to the surfaces of the reinforcing fibers, and the coupling agent may comprise an organofunctionalized silane having at least one carbon-silicon bond and at least one hydrolyzable bond.

In another refinement, depositing the metal plating on the exposed surface of the polymer substrate may comprise: 1) activating the exposed surface with a catalyst layer, 2) depositing a first layer on the catalyst layer by electroless deposition, 3) depositing a second conductive layer on the first layer by electrolytic deposition, and 4) depositing the metal plating on the second layer.

In another refinement, depositing the metal plating on the second layer may be performed by a method selected from the group consisting of electrolytic deposition, electroless deposition, and electroforming.

These and other aspects and features of the present disclosure will be more readily understood when read in conjunction with the accompanying drawings.

### BRIEF DESCRIPTION OF THE DRAWINGS

FIG. 1 is a front view of a plated polymer component having an adhesion promoter at the interface of a polymer substrate and a metal plating, constructed in accordance with the present disclosure.

FIG. 2 is a flow chart diagram, illustrating the steps involved in the formation of the plated polymer component of FIG. 1, in accordance with a method of the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use for certain applications. Hence, although the present disclosure is, for convenience of explanation, depicted and described as certain illustrative embodiments, it will be appreciated that it can be implemented in various other types of embodiments and in various other systems and environments.

### DETAILED DESCRIPTION

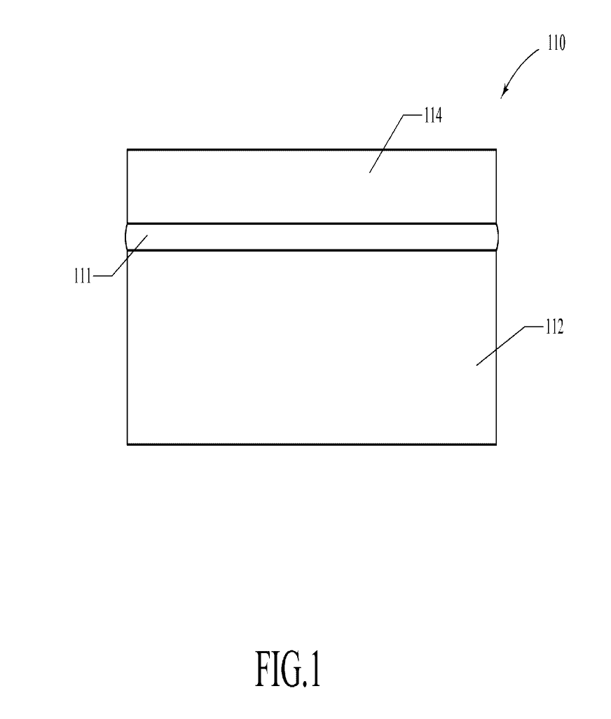

Referring now to FIG. 1, a plated polymer component 110 having an adhesion promoter 111 at the interface of a polymer substrate 112 and a metal plating 114 is shown. The component 110 may be a component of a gas turbine engine which is exposed to high temperatures and structural stress. Alternatively, the component 110 may be a component of another machine or structure requiring parts having high strength and high temperature stability. It is noted that the box-like structure depicted for the component 110 is exemplary and, in practice, the component 110 may have any structure suitable for its intended use, whether simple or complex. For example, it may have curved surfaces, asymmetric surfaces, and/or internal passages.

The use of chemical coupling agents in the adhesion promoter 111 as well as the use of optional coupling/sizing agents in the body of the polymer substrate 112 may substantially increase the structural resilience of the component 110 over plated polymer structures which lack such agents. Accordingly, the component 110 may exhibit enhanced fatigue resistance, enhanced fracture resistance, and service life such that it may be suitable for use in high temperature and/or structurally demanding regions of gas turbine engines or other structures.

The component 110 may have one or more metal platings 114 on one or more of its outer surfaces, as shown. The metal plating 114 may increase the structural resilience of the component 110 and may consist of a platable metal or metal alloy such as, but not limited to, nickel, cobalt, nickel-cobalt alloys, copper, iron, chromium, zinc, any other platable metal, and combinations thereof. The thickness of the metal plating 114 may be in the range of about 0.002 inches (0.05 mm) to about 0.14 inches (0.35 mm), but other metal plating thicknesses may also suffice.

The polymer substrate 112 may be formed from a thermoplastic or thermoset material. Suitable thermoplastic materials may include, but are not limited to, polyetherimide (PEI), thermoplastic polyimide, polyether ether ketone (PEEK), polyether ketone ketone (PEKK), polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymer substrate 114 may be structurally reinforced with one or more types of fillers or reinforcing fibers such as carbon fibers, glass fibers, or metal fibers. If reinforcing fibers are included in the polymer substrate 112, sizing agents/coupling agents may be applied to the surfaces of the reinforcing fibers to improve the strength of the bond between the polymer matrix and the reinforcing elements such that the body of the resulting polymer substrate 112 may have reduced susceptibility to fracturing and an increased service life. The sizing agents/coupling agents may be one or more different types of known sizing/coupling agents selected by a skilled artisan. As one non-limiting possibility, the coupling agent may be an organofunctionalized silane having at least one carbon-silicon bond (e.g., C—Si) and at least one hydrolyzable bond (e.g., Si—OR). More particularly, the organofunctionalized silane may have the general structure Y—Si(OR)ₙ where Y and OR are different types of reactive groups, Y is an organic group connected to the silicon atom by a carbon-silicon bond, the number of Y groups attached to the silicon atom may be between 1 and 3, and n may be between 1 and 4.

The adhesion promoter 111 may improve the adhesion between the metal plating 114 and the polymer substrate 112 and improve the overall structural resilience of the component. The adhesion promoter 111 may be any suitable adhesion promoter selected by a skilled artisan such as, but not limited to, an organofunctionalized silane having the general structure Y—Si(OR)ₙ where Y and OR are different types of reactive groups, Y is an organic group connected to the silicon atom by a carbon-silicon bond, the number of Y groups attached to the silicon atom may be between 1 and 3, and n may be between 1 and 4. Notably, Y and OR may be different types of reactive groups in order to provide coupling between the organic material (the polymer substrate 112) and the inorganic material (the metal plating 114). The introduction of the adhesion promoter 111 (a chemical activator) at the interface of the metal plating 114 and the polymer substrate 112 may reduce or eliminate the need for mechanical surface activation (i.e., etching, abrasion, etc.) typically used for activating the polymer surface prior to deposition of the metal plating 114.

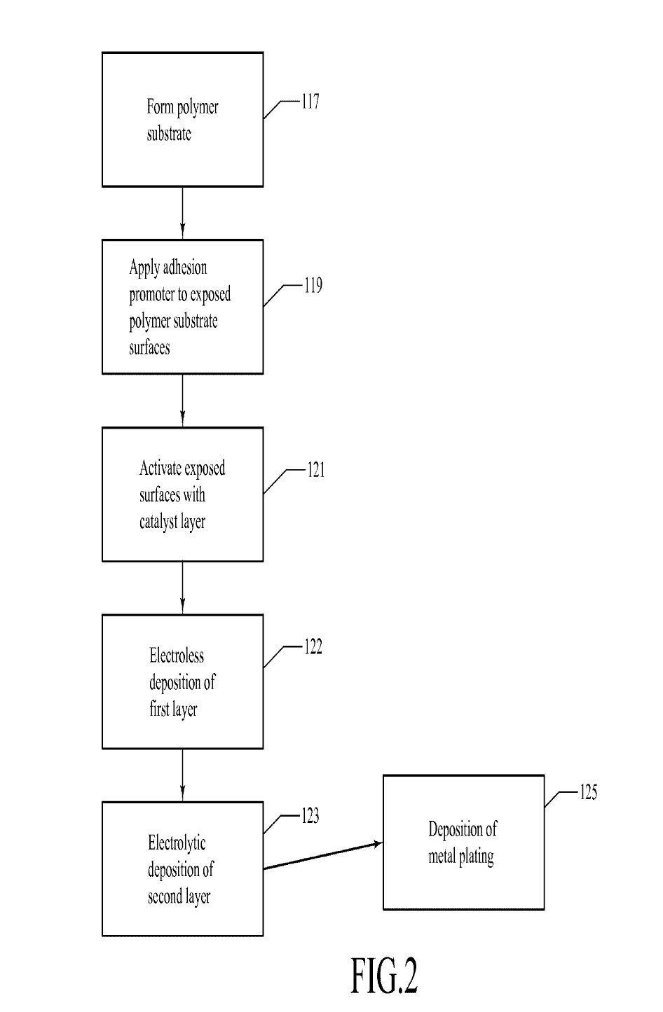

A series of steps which may be involved in the fabrication of the component 110 is depicted in FIG. 2. Beginning with a first block 117, the polymer substrate 112 having a desired shape may be formed by one or more methods apparent to those of ordinary skill in the art such as, but not limited to, injection molding, compression molding, blow molding, additive manufacturing (liquid bed, powder bed, deposition processes), or by composite layup (autoclave, compression, or liquid molding) as a neat resin of the selected polymer material or with optional filler or fiber reinforcement and sizing/coupling agents at the interface of the reinforcing fibers and the polymer material matrix. According to a next block 119, the adhesion promoter 111 may be applied to selected exposed surfaces of the polymer substrate 112 which are to be plated with a metal. Moreover, if desired or necessary, polymer surface etching or abrasion may be performed prior to the block 119.

Following the block 119, the selected exposed surfaces of the polymer substrate may be activated by application of a catalyst layer according to a block 121, as shown. The catalyst layer may consist of palladium, although platinum and gold are other possibilities. The catalyst layer may be applied to a thickness on the atomic scale. Electroless deposition of a first layer on catalyst layer followed by electrolytic deposition of a second layer on the first layer may then be performed according to the blocks 122 and 123, respectively. Both electroless deposition and electrolytic deposition are metal deposition methods well-understood by those having ordinary skill in the art. The first layer may be nickel, although copper, gold, silver, and graphite are other possibilities. The second layer may be copper or another suitable conductive material. At this stage, the treated outer surfaces of the polymer substrate 112 may have surface characteristics similar to a metal (e.g., conductivity) such that deposition of the metal plating 114 directly thereon may be performed according to the block 125, as shown. The deposition of the metal plating 114 on the second layer may be carried out using a metal deposition technique apparent to those having ordinary skill in the art such as, but not limited to, electrolytic deposition, electroless deposition, or electroforming. If desired, certain surfaces of the polymer substrate 112 may be blocked to prevent deposition of metal plating layers thereon by the use of masking techniques well-known in the industry. Following the block 125, if desired, additional metal plating layers having the same or different compositions may be deposited by electrolytic plating or by another plating technique apparent to those of ordinary skill in the art.

### INDUSTRIAL APPLICABILITY

From the foregoing, it can therefore be seen that the use of adhesion promoters at the interface of polymer substrates and metal plating layers in plated polymer components may substantially increase the inter-facial bond strength between the polymer substrate and the metal plating layer. As the inter-facial bond strength in plated polymer components have been the weak point of these materials in the past, the plated polymer components as disclosed herein may exhibit reduced tendency for premature failure and fracturing. The technology as disclosed herein may be particularly applicable in industries requiring high strength, high performance, and lightweight materials, such as, but not limited to, automotive, aerospace, and sporting industries.

What is claimed is:

1. A plated polymer component, comprising:
a polymer substrate having an outer surface;
a metal plating deposited on the outer surface of the polymer substrate; and
an adhesion promoter at an interface between the polymer substrate and the metal plating.

2. The plated polymer component of claim 1, wherein the adhesion promoter comprises an organofunctionalized silane.

3. The plated polymer component of claim 2, wherein the organofunctionalized silane has a structure Y—Si(OR)ₙ, where Y is an organic group, and where Y and R are different types of reactive groups.

4. The plated polymer component of claim 3, wherein the metal plating consists of a metal or metal alloy selected from the group consisting of nickel, cobalt, a nickel-cobalt alloy, copper, iron, chromium, zinc, and combinations thereof.

5. The plated polymer component of claim 3, wherein the polymer substrate is formed from a thermoplastic material or a thermoset material.

6. The plated polymer component of claim 5, wherein the polymer substrate is reinforced with reinforcing fibers selected from the group consisting of carbon fibers, glass fibers, and metal fibers.

7. The plated polymer component of claim 6, wherein a coupling agent is applied to the surfaces of the reinforcing fibers.

8. The plated polymer component of claim 7, wherein the coupling agent that is applied to the surfaces of the reinforcing fibers is an organofunctionalized silane having at least one carbon-silicon bond and at least one hydrolyzable bond.

9. The plated polymer component of claim 8, wherein the organofunctionalized silane that is applied to the surfaces of the reinforcing fibers has a structure Y—Si(OR)ₙ, where Y is an organic group, and where Y and R are different types of reactive groups.

10. A method of fabricating a plated polymer component, comprising:
forming a polymer substrate in a desired shape;
applying an adhesion promoter to an exposed surface of the polymer substrate; and
depositing a metal plating on the exposed surface of the polymer substrate.

11. The method of claim 10, wherein the adhesion promoter comprises an organofunctionalized silane.

12. The method of claim 11, wherein the organofunctionalized silane has a structure Y—Si(OR)ₙ, where Y is an organic group, and where Y and R are different types of reactive groups.

13. The method of claim 12, wherein the polymer substrate is formed with reinforcing fibers and a coupling agent is applied to the surfaces of the reinforcing fibers, and wherein the coupling agent comprises an organofunctionalized silane having at least one carbon-silicon bond and at least one hydrolyzable bond.

14. The method of claim 12, wherein depositing the metal plating on the exposed surface of the polymer substrate comprises:
activating the exposed surface with a catalyst layer;
depositing a first layer on the catalyst layer by electroless deposition;
depositing a second layer on the first layer by electrolytic deposition, the second layer being conductive; and
depositing the metal plating on the second layer.

15. A plated polymer component comprising a polymer substrate and a metal plating deposited on an outer surface of the polymer substrate, the plated polymer component being fabricated by a method comprising:
forming the polymer substrate in a desired shape;
applying an adhesion promoter to the exposed surface of the polymer substrate; and
depositing the metal plating on the exposed surface of the polymer substrate.

16. The plated polymer component of claim 15, wherein the adhesion promoter comprises an organofunctionalized silane.

17. The plated polymer component of claim 16, wherein the organofunctionalized silane has a structure Y—Si(OR)ₙ, where Y is an organic group, and where Y and R are different types of reactive groups.

18. The plated polymer component of claim 15, wherein the polymer substrate is formed with reinforcing fibers and a coupling agent is applied to the surfaces of the reinforcing fibers, and wherein the coupling agent comprises an organofunctionalized silane having at least one carbon-silicon bond and at least one hydrolyzable bond.

19. The plated polymer component of claim 15, wherein depositing the metal plating on the exposed surface of the polymer substrate comprises:
activating the exposed surface with a catalyst layer;
depositing a first layer on the catalyst layer by electroless deposition;
depositing a second layer on the first layer by electrolytic deposition, the second layer being conductive; and
depositing the metal plating layer on the second layer.

20. The plated polymer component of claim 19, wherein depositing the metal plating on the second layer is performed by a method selected from the group consisting of electrolytic deposition, electroless deposition, and electroforming.
